(19) United States
(12) Patent Application Publication
(10) Pub. No.: US 2008/0007531 A1
(43) Pub. Date: Jan. 10, 2008

(54) Keyboard with application program and execution function

(76) Inventor: Chien-Tsung Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/074,503

(22) Filed: Mar. 7, 2005

(30) Foreign Application Priority Data
Jul. 19, 2004 (TW) 093211387

(51) Int. Cl. G06F 3/02

(52) U.S. Cl. 345/172

(57) ABSTRACT

The present invention provides a keyboard with application program and capable of execution function by itself, comprising: at least one set of keyboard numeric code information, including Windows front numeric code information and executable file path numeric code information; at least one hotkey, with each hotkey corresponding to the keyboard numeric code information; and a microprocessor, outputting the keyboard numeric code information when its corresponding hotkey is pressed and prompting a computer to immediately execute a executable file corresponding to the keyboard numeric code information.

### BACKGROUND OF THE INVENTION

1. Field of the Invention

The present invention relates to a keyboard, more particularly to a keyboard with application program and execution function.

2. Description of the Prior Art

Currently there are two ways to execute application programs with hotkeys on a keyboard. One way is to codify hotkeys with definitions in accordance to Microsoft Windows system. Once recognized by the system, these hotkeys are capable of executing their corresponding Windows application programs by themselves. For example, in Microsoft Windows system the code “EO 3A” triggered by a hotkey executes internet surfing function. The other way is to employee a driver. The existing hotkey numeric code information is not compatible to the Microsoft Windows system. A supplement driver is employed, operates in a computer continually, and monitors that if a hotkey numeric code is input in the computer. If true, the driver would prompt execution of a Windows application program corresponding to the hotkey pressed.

The first type of hotkeys is few in number and cannot fulfill the need of increasing number of application programs. The second type, however, relies on a driver for their function. The design and maintenance of a driver cause cost increase and the inconvenience of installation for users.

The present invention is made to overcome the above-mentioned problems of the related arts, and it is an object of the present invention to provide a keyboard with application programs. It can perform execution function without a driver. Upon pressing a hotkey, an user can prompts a computer to execute the corresponding application program.

### SUMMARY OF THE INVENTION

The primary objective of the present invention is to provide a keyboard with hotkey function without the need of a driver. When an user presses a hotkey, its corresponding application program would be executed by a computer.

To achieve the purpose of this present invention, the present invention provides a keyboard with application program and capable of execution function by itself, comprising: at least one set of keyboard numeric code information, including Windows front numeric code information and executable file path numeric code information; at least one hotkey, with each hotkey corresponding to the keyboard numeric code information; and a microprocessor, outputting the keyboard numeric code information when its corresponding hotkey is pressed and prompting a computer to immediately execute a executable file corresponding to the keyboard numeric code information.

### BRIEF DESCRIPTION OF THE DRAWINGS

The foregoing and other features and advantages of the present invention will be more clearly understood from the following detailed description and the accompanying drawings, in which:

FIG. 1 shows the circuit connection of the keyboard of the present invention;

FIG. 2 is a perspective view showing the keyboard of the present invention;

FIG. 3 shows the structure of the keyboard numeric code information of the present invention;

FIG. 4A to 4C show one embodiment of the keyboard numeric code information used in Microsoft Windows system.

FIG. 5 is an operation flow chart of the microcontroller of the present invention;

FIG. 6A to 6B show pictures on a monitor when the keyboard of the present invention performs execution in Windows operating system;

FIG. 7A shows the first picture on a monitor when the keyboard of the present invention by itself executing the virtual hotkey in a computer; and

FIG. 7B shows the second picture on a monitor when the keyboard of the present invention by itself executing the virtual hotkey in a computer.

### DETAILED DESCRIPTION OF THE PREFERRED EMBODIMENT

The following description of the preferred embodiments discloses specific configurations, data value, and components. The description of various features and structures of the present invention which would be known to one skilled in the art are omitted for the sake of clarity and brevity.

The present invention is to provide a keyboard 10 with hotkeys 109 capable of executing their corresponding application programs. When an user presses a hotkey 109, its corresponding application program would be executed in a computer without any driver. Also, the application programs are not limited to those hotkey numeric codes defined in Windows operating system. Undefined programs could be carried out with the hotkeys 109.

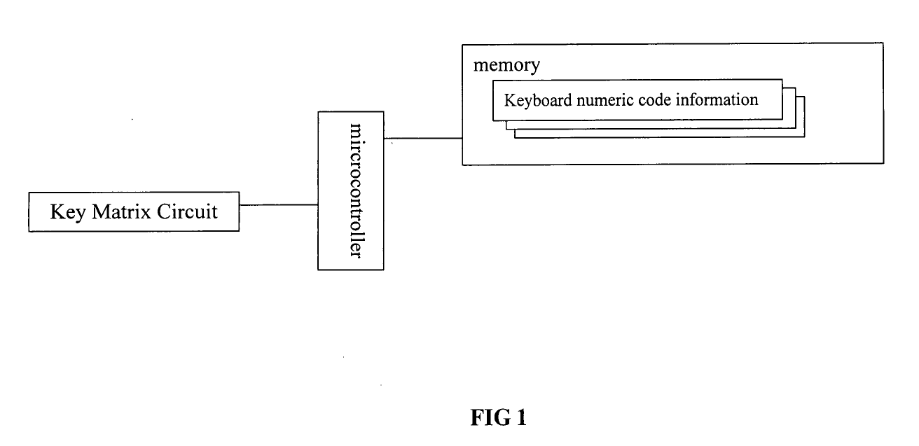

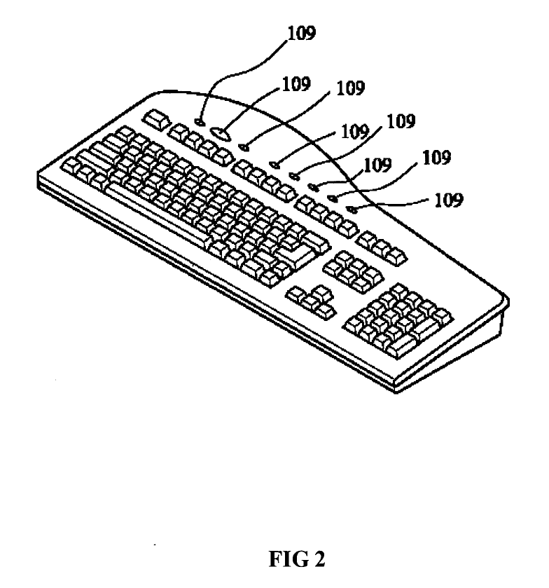

FIG. 1 and FIG. 2 show the circuit connection and the perspective view of the keyboard of the present invention, respectively. The keyboard 10 of the present invention comprises at least one set of keyboard numeric code information 107, at least one hotkey 109, and a microcontroller 101. Details for the present invention are described below.

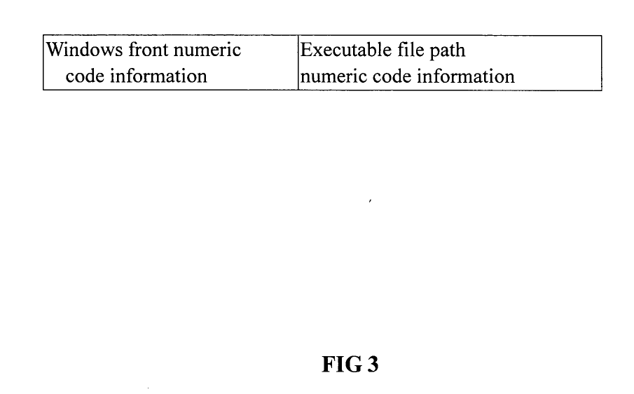

As shown in FIG. 3, the keyboard numeric code information 107 comprises the Windows front numeric code information 107A and executable file path numeric code information 107B. The keyboard numeric code information 107 is stored in memory 105, such as a nonvolatile memory.

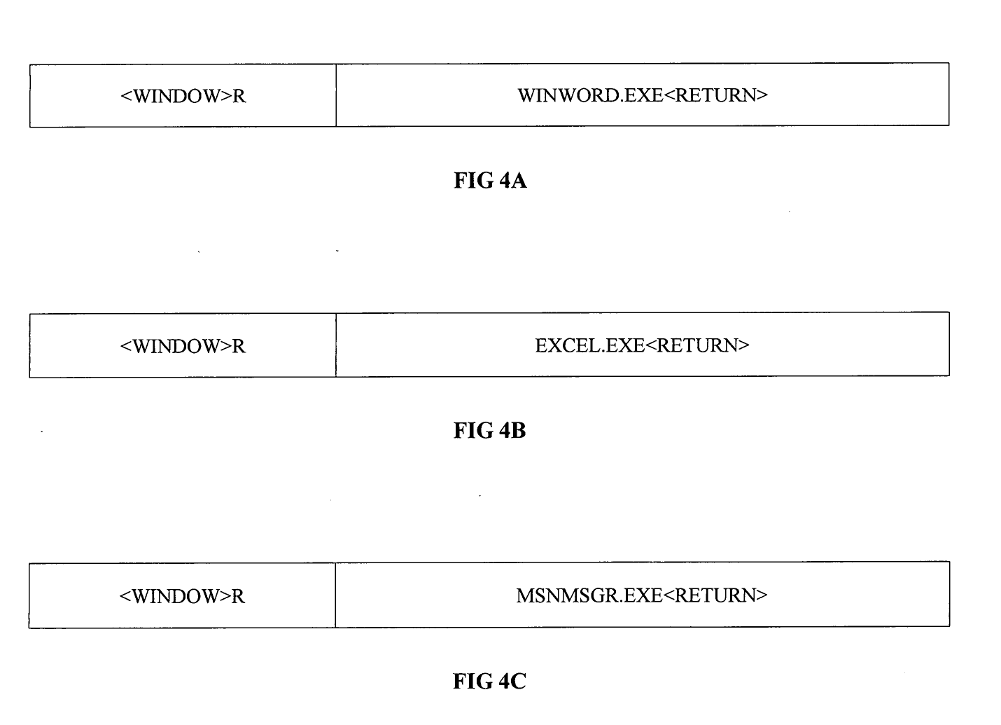

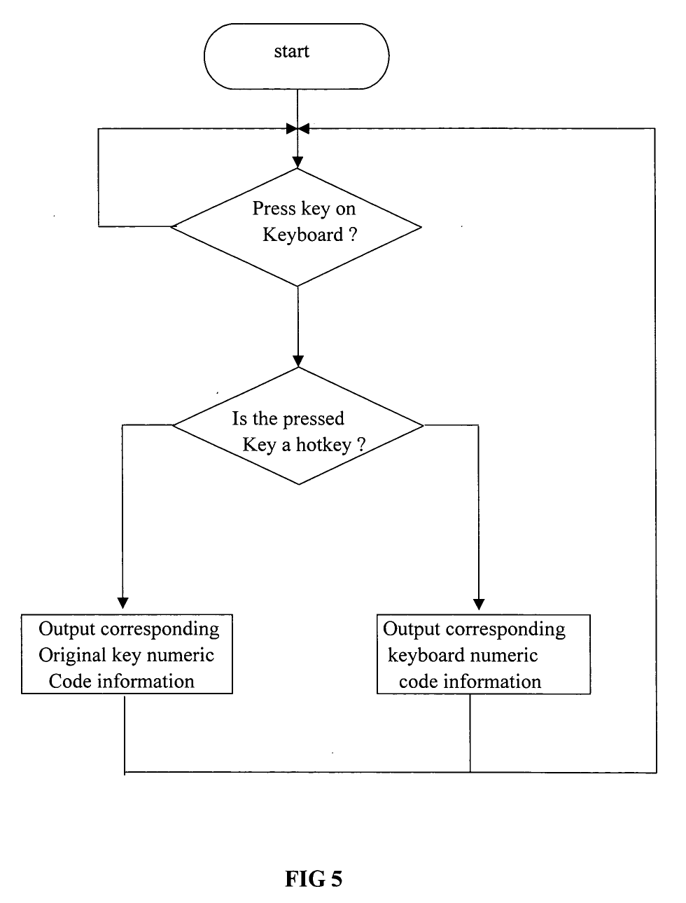

FIGS. 4A to 4C shows several embodiments of the keyboard numeric code information used in the Windows operating system. Therefore, the embodiment of keyboard numeric code information 107 is chosen according to the type of Windows operating system. As shown in FIG. 4A and FIG. 4B, the embodiment of the Windows front numeric code information 107A is determined to be “<Windows Logo> R” defined by the Windows operating system. One skilled in the art would adapt different Windows front numeric code information in accordance with the Windows operating system. The embodiments of the executable file path numeric code information 107B are: “WINWORD.EXE <RETURN>”, “EXCEL.EXE <RETURN>”, and “MANMSGR.EXE <RETURN>”. One skilled in the art would readily adapt a executable file path numeric code information according to the Windows operating system and the type of application program.

The present invention adapts Key Matrix Circuit 103 to assign hotkeys 109. The hotkeys 109 correspond to a set of keyboard numeric code information 107. One embodiment of the hotkeys is single key. The other is a combination of singles keys, such as the combinations of hotkeys [F1] and [A], [F1] and [B], [F1] and [C] and so on. The combination of hotkeys 109 [F1] and [A] corresponds to keyboard numeric code information 107 “<Windows Logo> R WINWORD.EXE <RETURN>”. The combination of hotkeys 109 [F1] and [B] corresponds to keyboard numeric code information 107 “<Windows Logo> R EXCEL.EXE <RETURN>”.

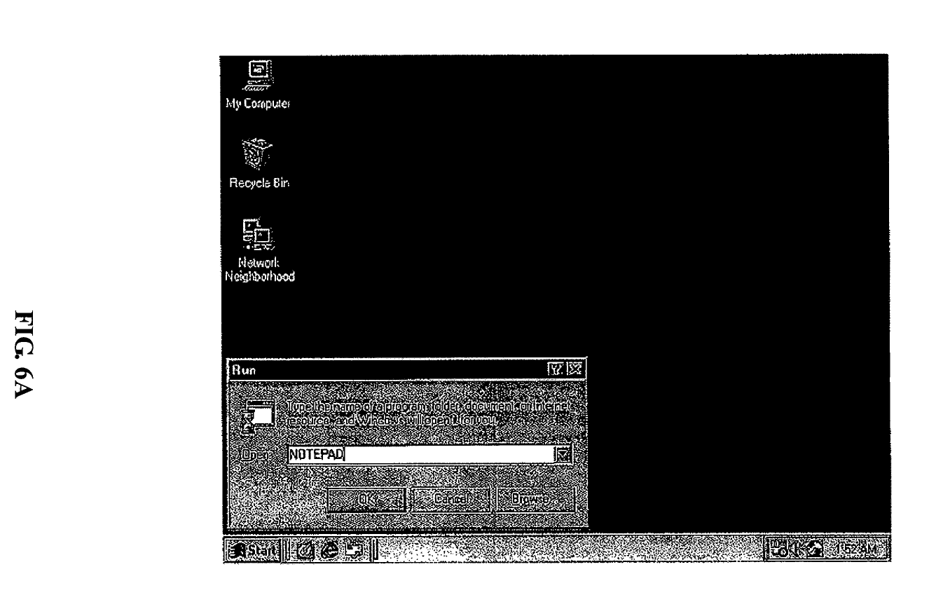

FIG. 5 shows the operation flow chart for microcontroller of the present invention. The microcontroller 101 checks whether any key on the keyboard 10 is pressed. If true, the microcontroller 101 checks if the pressed key is a hotkey. If not, it continues to check if any key is pressed. If a hotkey 109 is pressed, the microcontroller 101 outputs its corresponding keyboard numeric code information 107. For example, if the combination of hotkeys 109 [F1] and [B] are pressed, the microcontroller 101 would output to keyboard numeric code information 107 “<Windows Logo> R EXCEL.EXE <RETURN>”. In the case that the key pressed is not a hotkey 109, the microcontroller 101 would output its corresponding original key numeric code information, such as that for key [B] if it is pressed by itself. Furthermore, another embodiment of present invention could be combinations of key [Fn] with other single keys.

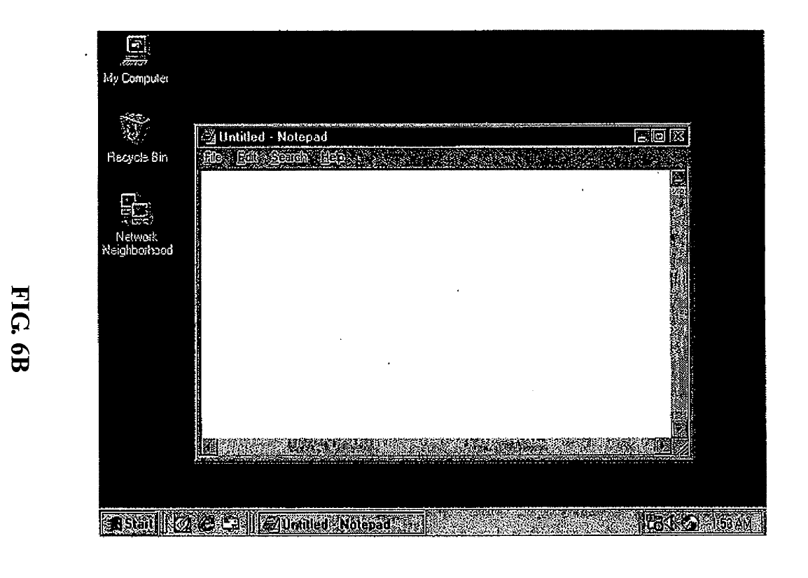

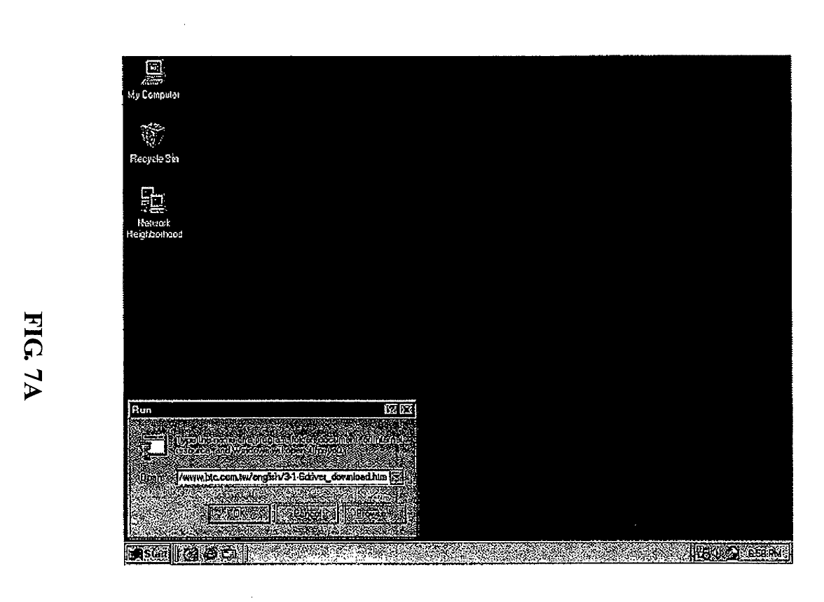

FIGS. 6A and 6B show the pictures of keyboard operations with the present invention in Windows operation system. If an user press a hotkey 109 in the keyboard 10 and the hotkey 109 corresponds to keyboard numeric code information “<Windows Logo> R NOTEPAD.EXE <RETURN>”, the monitor would show the picture in FIG. 6A and followed by the picture in FIG. 6B. Simultaneously the computer enters the “notepad” Windows application program.

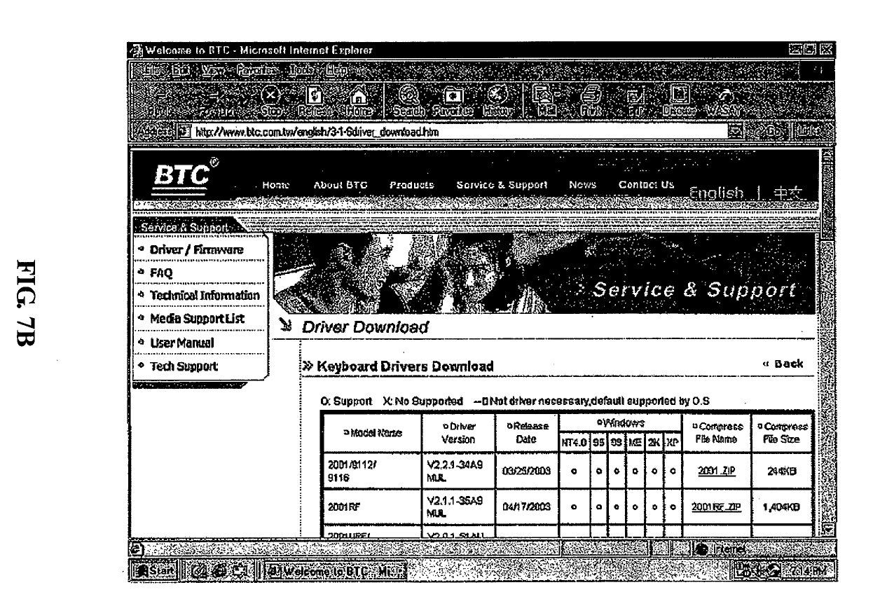

The microcontroller 101 of the present invention is capable of outputting keyboard numeric code information 107. The further enhance its capability, the keyboard 10 of the present invention possess a “virtual hotkey” used at the time of keyboard installation. The virtual hotkey of the present invention functions to connect internet and download webpages related to keyboard 10 drivers. When a user install for the first time the keyboard 10 of this present invention, the microcontroller activates the virtual hotkey mechanism, outputs “<Windows Logo> R http://www.btc.com.tw/english/3-1-6driver_download.htm<RETURN>”. As shown in FIG. 7A, for example, the keyboard of the present invention by itself executes the virtual hotkey. Followed, the computer by itself connects and shows the driver download page, as shown in FIG. 7B.

The present invention enhance keyboard capability in the following ways: 1. The computer does not require a driver for hotkeys. The hotkeys are ready to use upon keyboard installation; 2. The application programs for hotkeys could be altered according to the needs of manufacturers. Even with new Windows Operating Systems, manufacturers can update their keyboard numeric code information and the keyboard is ready for new systems; 3. The keyboard of the present invention is made of known standard keyboard hardware and adapted to the firmware of the present invention. There is no increase of manufacturing cost, yet added value for the keyboard.

Although the present invention has been illustrated and described with reference to the preferred embodiment thereof, it should be understood that it is in no way limited to the details of such embodiment but is capable of numerous modifications within the scope of the appended claims.

What is claimed is:

1. A keyboard with application programs and execution function, comprising:
at least one set of keyboard numeric code information, including Windows front numeric code information and executable file path numeric code information;
at least one hotkey, with each hotkey corresponding to said keyboard numeric code information;
a microcontroller, outputting said keyboard numeric code information when its corresponding hotkey is pressed and prompting a computer to immediately execute a executable file corresponding to said keyboard numeric code information.

2. The keyboard as claimed in claim 1, wherein said executable file is a Windows application program.

3. The keyboard as claimed in claim 1, wherein said Windows front numeric code information is <Windows Logo> R numeric code information.

4. The keyboard as claimed in claim 1, wherein said keyboard is a keyboard functions in Windows operating system.

5. The keyboard as claimed in claim 1, wherein said Windows front numeric code information can be re-defined according to different Windows operating systems.

6. The keyboard as claimed in claim 1, wherein said executable file path numeric code information comprises:
at least one WINWORD.EXE numeric code information.

7. The keyboard as claimed in claim 1, wherein said executable file path numeric code information comprises:
at least one EXCEL.EXE numeric code information.

8. The keyboard as claimed in claim 1, wherein said executable file path numeric code information comprises:
at least one MSNMSGR.EXE numeric code information.

9. The keyboard as claimed in claim 1, wherein said hotkey comprises:
one single hotkey.

10. The keyboard as claimed in claim 1, wherein said hotkey comprises:
a combination of more than one single hotkey.

11. The keyboard as claimed in claim 1, further comprises:
at least one virtual hotkey, corresponding to a set of said keyboard numeric code information.
